(19) United States
(12) Patent Application Publication
(10) Pub. No.: US 2024/0279500 A1
(43) Pub. Date: Aug. 22, 2024

(54) INKJET INK

(71) Applicant: KYOCERA Document Solutions Inc., Osaka (JP)

(72) Inventor: Kazuki TSUCHIHASHI, Osaka-shi (JP)

(73) Assignee: KYOCERA Document Solutions Inc., Osaka (JP)

(21) Appl. No.: 18/172,980

(22) Filed: Feb. 22, 2023

(51) Int. Cl. C09D 11/38; C09D 11/322

(52) U.S. Cl. CPC C09D 11/38; C09D 11/322

(57) ABSTRACT

An inkjet ink contains a pigment, specific resin particles, and an aqueous medium. The aqueous medium contains water, a first organic solvent, and a second organic solvent. The first organic solvent is at least one of 3-methyl-1,3-butanediol, ethylene glycol monomethyl ether, and dipropylene glycol. The second organic solvent has a surface tension of at least 25.0 mN/m and no greater than 35.0 mN/m. The specific resin particles contain a fluorine-containing (meth)acrylic resin.

### BACKGROUND

The present disclosure relates to an inkjet ink.

It is required for inkjet inks used in inkjet recording apparatuses to be able to form images with desired image density and excellent scratch resistance.

To address requirements as above, an inkjet ink is proposed for example that contains a pigment, a wax, a water-soluble solvent, and water. The above inkjet ink is said to be able to form images with high density and excellent scratch resistance.

### SUMMARY

An inkjet ink according to an aspect of the present disclosure contains a pigment, specific resin particles, and an aqueous medium. The aqueous medium contains water, a first organic solvent, and a second organic solvent. The first organic solvent is at least one of 3-methyl-1,3-butanediol, ethylene glycol monomethyl ether, and dipropylene glycol. The second organic solvent has a surface tension of at least 25.0 mN/m and no greater than 35.0 mN/m. The specific resin particles contain a fluorine-containing (meth)acrylic resin.

### DETAILED DESCRIPTION

The following describes an embodiment of the present disclosure. In the present specification, the units of the dispersion energy (dD), polar energy (dP), and hydrogen bonding energy (dH) of the Hansen solubility parameters are all [MPa^{0.5}].

The term surface tension refers to a value as measured at a liquid temperature of 25° C. by Wilhelmy plate method using a surface tensiometer (e.g., “DY-300”, product of Kyowa Interface Science Co., Ltd.). Measurement values for volume median diameter (D₅₀) are values as measured using a dynamic light scattering particle size distribution analyzer (e.g., “ZETASIZER ZS”, product of Malvern Instruments Ltd.) unless otherwise stated.

In the present specification, the term “(meth)acryl” is used as a generic term for both acryl and methacryl. Each component described in the present specification may be used independently or in combination of two or more types thereof.

### <Inkjet Ink>

The following describes an inkjet ink (also referred to below simply as ink) according to an embodiment of the present disclosure. The ink of the present disclosure contains a pigment, specific resin particles, and an aqueous medium. The aqueous medium contains water, a first organic solvent, and a second organic solvent. The first organic solvent is at least one of 3-methyl-1,3-butanediol, ethylene glycol monomethyl ether, and dipropylene glycol. The second organic solvent has a surface tension of at least 25.0 mN/m and no greater than 35.0 mN/m. The specific resin particles contain a fluorine-containing (meth)acrylic resin.

The first organic solvent in the ink of the present disclosure is selected in view of Hansen solubility parameters (HSP). The HSP will be described first. The HSP are values used for prediction of solubility of a substance. The HSP include the following three parameters (unit: MPa^{0.5}).

Dispersion energy (dD): energy from dispersion forces between molecules

Polar energy (dP): energy from dipolar intermolecular forces between molecules

Hydrogen bonding energy (dH): energy from hydrogen bonds between molecules

The three parameters of the HSP can be treated as coordinates for a point in three dimensions also known as the Hansen space. When two specific substances are placed in the Hansen space, the closer to each other the coordinates of the two substances are, the more approximate the properties of the two substance tend to be.

The HSP of a substance with unknown HSP can be measured by the following method. First, 1 part by mass of a substance (also referred to below as target substance) of which HSP are to be measured and 49 parts by mass of a solvent (e.g., a solvent with a literature value) with known HSP are charged into a sealable vessel. Next, the vessel was hand-shaken to sufficiently mix the target substance and the solvent. Next, the vessel is left to stand for 12 hours in a normal temperature (23° C.) environment. Next, the vessel is turned upside down and the bottom of the vessel is observed. Where neither precipitate nor agglomerate are present at the bottom of the vessel, the solvent is determined to have dissolved the target substance. The above test is repeated with the type of the solvent changed as appropriate. Through the above, a combination of 10 solvents is determined that includes solvents that dissolve the target substance and solvents that do not dissolve the target substance. Preferably, of the 10 solvents in the combination, about half (e.g., 4 to 6) are solvents that dissolve the target substance while the other solvents are solvents that do not dissolve the target substance. Based on the test results with respect to the 10 solvents, a sphere called Hansen sphere is drawn in the Hansen space.

Examples of the combination of 10 solvents in the present specification is shown below in Table 1.

TABLE 1

| | dD | dP | dH |
|---|---|---|---|
| Triethylene glycol monobutyl ether | 15.9 | 7.2 | 14.0 |
| 3-Methyl-1,5-pentanediol | 16.9 | 8.0 | 17.4 |
| 1,5-Pentanediol | 17.0 | 8.9 | 18.9 |
| Diethylene glycol | 16.2 | 6.1 | 9.1 |
| Propylene glycol | 16.8 | 10.4 | 21.3 |
| Ethylene glycol | 17.0 | 11.0 | 26.0 |
| Glycerin | 17.4 | 11.3 | 27.2 |
| 2-Pyrrolidone | 18.2 | 12.0 | 9.0 |
| Triethylene glycol | 16.0 | 12.5 | 18.6 |
| 1,3-Propanediol | 16.8 | 13.5 | 23.2 |

How to draw the Hansen sphere will be explained here. In the Hansen space, a sphere (Hansen sphere) is drawn that includes the coordinates of the solvents that have dissolved the target substance and that does not include the coordinates of the solvents that have not dissolved the target substance. The coordinates at the center of the drawn Hansen sphere indicate the HSP of the target substance. The size of the Hansen sphere differs depending on the type of the target substance. In detail, a target substance that is soluble in various solvents different in property has a large radius R₀ of the Hansen sphere. By contrast, a target substance that is soluble only in limited solvents different in specific property has a small radius R₀ of the Hansen sphere.

A specific method for predicting solubility of two substances (e.g., a solvent X and a solute Y) based on the HSP will be described next. First, the two substances are placed in the Hansen space based on the HSP thereof. Thereafter, a distance Rₐ between the two substances is calculated. The shorter the distance Rₐ is, the easier it is for the two substances to dissolve in each other. The distance Rₐ between the two substances can be calculated using the following equation (R).

$${R}_{a} = \sqrt{4 \times {( dDx - dDy )}^{2} + {( dPx - dPy )}^{2} + {( dHx - dHy )}^{2}} \qquad ( R )$$

In equation (R), dDx, dPx, and dHx respectively represent the dispersion energy (dD), the polar energy (dP), and the hydrogen bonding energy (dH) of the solvent X. dDy, dPy, and dHy respectively represent the dispersion energy (dD), the polar energy (dP), and the hydrogen bonding energy (dH) of the solute Y.

When the above is applied to the ink of the present disclosure, the distance Rₐ between a solvent and the pigment particles in the Hansen space can be calculated using the following equation (R-1).

$${R}_{a} = \sqrt{4 \times {( dDs - dDp )}^{2} + {( dPs - dPp )}^{2} + {( dHs - dHp )}^{2}} \qquad ( R - 1 )$$

In equation (R-1), dDs, dPs, and dHs respectively represent the dispersion energy (dD), the polar energy (dP), and the hydrogen bonding energy (dH) of the solvent. dDp, dPp, and dHp respectively represent the dispersion energy (dD), the polar energy (dP), and the hydrogen bonding energy (dH) of the pigment particles.

Whether or not the solute Y is soluble in the solvent X is determined according to whether or not the Hansen sphere of the solute Y includes the coordinates of the HSP of the solvent X in the Hanse space. Specifically, whether or not the solute Y is soluble in the solvent X is determined according to the magnitude of a ratio (Rₐ/R₀) of the distance Rₐ between the two substances to the radius R₀ of the Hansen sphere of the solute Y. In the following, the ratio (Rₐ/R₀) may be referred to as relative energy difference (RED, see equation (r) below). Where the RED is less than 1, the coordinates of the HSP of the solvent X are present within the Hansen sphere of the solute Y. Therefore, the solute Y is soluble in the solvent X. Where the RED is greater than 1 by contrast, the coordinates of the HSP of the solvent X are present outside the Hansen sphere of the solute Y. Therefore, the solute Y is insoluble in the solvent X. Note that where the RED is just 1, the solute Y is partially soluble in the solvent X.

$$RED = {R}_{a} / {R}_{0} \qquad ( r )$$

In a case in which the solvent X is a solvent mixture, the HSP of the solvent X can be calculated by the following method. With respect to each solvent included in the solvent X, a product A of the dispersion energy (dD) of the solvent and the mass ratio of the solvent (ratio of the mass of the solvent to the mass of the solvent X) is calculated first. Next, the products A of the respective solvents are summed to calculate a sum B. The sum B is taken to be a dispersion energy (dD) of the solvent mixture. A polar energy (dP) and a hydrogen bonding energy (dH) of the solvent X can be calculated according to the same method as that for calculating a dispersion energy (dD) of the solvent X. Thus, the HSP of the solvent X being a solvent mixture is calculated.

As a result of having the above features, the ink of the present disclosure can form images with desired image density and excellent scratch resistance. The reasons therefor will be explained below. The ink of the present disclosure contains the first organic solvent (3-methyl-1,3-butanediol, ethylene glycol monomethyl ether, or dipropylene glycol). The first organic solvent and the pigment each with a RED in the Hansen solubility parameters of about 0.6 to 1.2 are relatively highly compatible with each other. Therefore, the first organic solvent moderately decreases dispersion stability of the pigment in the ink of the present disclosure. This makes it ready to agglomerate the pigment on the surface of a recording medium once the ink of the present disclosure lands on the recording medium. The pigment agglomerating on the surface of the recording medium stays on the surface of the recording medium without permeating thereinto. As a result, the ink of the present disclosure can form images with sufficient image density even in a situation in which high image density is required.

By contrast, the pigment staying on the surface of a sheet of a recording medium may cause a phenomenon in which the pigment attaches to another member (e.g., another sheet of the recording medium) upon the surface of the sheet of the recording medium rubbing against the other member. The phenomenon tends to occur when the solvent remains on the surface of the recording medium. By contrast, the ink of the present disclosure contains the second organic solvent. The second organic solvent has surface tension lower than water. As a result of containing the second organic solvent, the ink of the present disclosure can allow the aqueous medium to quickly permeate into the recording medium while leaving mainly the pigment on the surface of the recording medium once the ink lands on the recording medium.

Furthermore, the ink of the present disclosure contains the specific resin particles containing a fluorine-containing (meth)acrylic resin. Once the ink of the present disclosure lands on the recording medium, the specific resin particles stay on the surface of the recording medium to cover the pigment, thereby protecting the pigment. The fluorine-containing (meth)acrylic resin is a resin based on (meth)acrylic resin. The specific resin particles are accordingly excellent in dispersion stability. Furthermore, the fluorine-containing (meth)acrylic resin is one type of fluororesin. As such, the specific resin particles have a low friction coefficient. Therefore, the specific resin particles decrease the friction coefficient of the surface of an image formed with the ink of the present disclosure to effectively protect the pigment attaching to the sheet of the recording medium. Thus, the ink of the present disclosure can form images with excellent scratch resistance. Each component of the ink of the present disclosure will be described below.

### [Pigment]

The pigment in the ink of the present disclosure constitutes pigment particles together with a pigment coating resin. The pigment particles each include a core containing the pigment and the pigment coating resin covering the core. The pigment coating resin is present in an aqueous medium in a dispersed manner, for example. From the viewpoint of increasing color density, hue, or stability of the ink of the present disclosure, the pigment particles have a D₅₀ of preferably at least 30 nm and no greater than 200 nm, and more preferably at least 70 nm and no greater than 130 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, specifically, 15:3). Examples of the violet pigments include C.I. Pigment Violet (19, 23, or 33). Examples of the black pigments include C.I. Pigment Black (7).

The pigment has a percentage content of preferably at least 3.0% by mass and no greater than 20.0% by mass in the ink of the present disclosure, and more preferably at least 6.0% by mass and no greater than 12.0% by mass. As a result of the percentage content of the pigment being set to at least 3.0% by mass, the ink of the present disclosure can further reliably form images with desired image density. As a result of the percentage content of the pigment being set to no greater than 20.0% by mass, ejection stability of the ink of the present disclosure can be increased.

### (Pigment Coating Resin)

The pigment coating resin is a resin soluble in the ink of the present disclosure. A portion of the pigment coating resin is present for example on the surfaces of the pigment particles to increase dispersibility of the pigment particles. Another portion of the pigment coating resin is present in a state of being dissolved in the ink of the present disclosure, for example. The pigment coating resin is preferably styrene-acrylic resin. The styrene-acrylic resin is a polymer of styrene and a monomer including at least one of (meth)acrylic acid alkyl ester and (meth)acrylic acid.

The pigment coating resin has a percentage content of preferably at least 1.0% by mass and no greater than 10.0% by mass in the ink of the present disclosure, and more preferably at least 3.0% by mass and no greater than 5.0% by mass.

### [Specific Resin Particles]

The specific resin particles contain a fluorine-containing (meth)acrylic resin. The fluorine-containing (meth)acrylic resin has a percentage content of preferably at least 90% by mass in the specific resin particles, and more preferably 100% by mass. The specific resin particles preferably have a D₅₀ of at least 20 μm and no greater than 300 μm.

### (Fluorine-Containing (Meth)Acrylic Resin)

The fluorine-containing (meth)acrylic resin is a resin including a repeating unit derived from a fluorine-containing monomer and a repeating unit derived from (meth)acrylic acid-based monomer. The fluorine-containing (meth)acrylic resin may further include a repeating unit (e.g., styrene unit) derived from a monomer that is neither a fluorine-containing monomer nor a (meth)acrylic acid-based monomer.

The fluorine-containing (meth)acrylic resin is preferably a block copolymer with a block ((meth)acrylic acid-based block) including a repeating unit derived from a (meth)acrylic acid-based monomer and a block (fluorine-containing block) including a repeating unit derived from a fluorine-containing monomer.

### ((Meth)Acrylic Acid-Based Monomer)

Examples of the (meth)acrylic acid-based monomer include (meth)acrylic acid and (meth)acrylic acid alkyl ester. Examples of the (meth)acrylic acid alkyl ester include methyl (meth)acrylate, ethyl (meth)acrylate, propyl (meth)acrylate, and butyl (meth)acrylate. The (meth)acrylic acid-based monomer is preferably methyl methacrylate, butyl acrylate, or acrylic acid.

The percentage content of the repeating unit derived from the (meth)acrylic acid-based monomer to all repeating units in the fluorine-containing (meth)acrylic resin is preferably at least 25.0% by mass and no greater than 75.0% by mass, and more preferably at least 40.0% by mass and no greater than 60.0% by mass. As a result of the percentage content of the repeating unit derived from the (meth)acrylic acid-based monomer being set to at least 25.0% by mass, the specific resin particles of the ink of the present disclosure can have increased dispersion stability. As a result of the percentage content of the repeating unit derived from the (meth)acrylic acid-based monomer being set to no greater than 75.0% by mass, the repeating unit derived from a fluorine-containing monomer can be sufficiently introduced into the fluorine-containing (meth)acrylic resin. Accordingly, images formed with the ink of the present disclosure can have further increased scratch resistance.

### (Fluorine-Containing Monomer)

Examples of the fluorine-containing monomer include vinyl fluoride, vinylidene fluoride, trifluoroethylene, tetrafluoroethylene, chlorotrifluoroethylene, bromotrifluoroethylene, pentafluoropropylene, and hexafluoropropylene. The fluorine-containing monomer is preferably vinylidene fluoride, tetrafluoroethylene, or chlorotrifluoroethylene.

The percentage content of the repeating unit derived from the fluorine-containing monomer to all the repeating units in the fluorine-containing (meth)acrylic resin is preferably at least 25.0% by mass and no greater than 75.0% by mass, and more preferably at least 40.0% by mass and no greater than 60.0% by mass. As a result of the percentage content of the repeating unit derived from the fluorine-containing monomer being set to at least 25.0% by mass, images formed with the ink of the present disclosure can have further increased scratch resistance. As a result of the percentage content of the repeating unit derived from the fluorine-containing monomer being set to no greater than 75.0% by mass, the specific resin particles of the ink of the present disclosure can have increased dispersion stability.

A combination of raw material monomers of the fluorine-containing (meth)acrylic resin is preferably a combination (I), and more preferably a combination (Ia) below.

Combination (I): vinylidene fluoride, tetrafluoroethylene, chlorotrifluoroethylene, methyl (meth)acrylate, butyl (meth)acrylate, and (meth)acrylic acid.

Combination (Ia): vinylidene fluoride, tetrafluoroethylene, chlorotrifluoroethylene, methyl methacrylate, butyl acrylate, and acrylic acid.

The percentage content of the specific resin particles in the ink of the present disclosure is preferably at least 2.0% by mass and no greater than 8.0% by mass, and more preferably at least 4.0% by mass and no greater than 6.0% by mass. As a result of the percentage content of the specific resin particles being set to at least 2.0% by mass, images formed with the ink of the present disclosure can have further increased scratch resistance. As a result of the percentage content of the specific resin particles being set to no greater than 8.0% by mass, the ink of the present disclosure can have increased ejection stability.

### [Aqueous Medium]

The aqueous medium contains water, a first organic solvent, and a second organic solvent. Preferably, the aqueous medium further contains glycerin. The aqueous medium may further contain even a small amount of a component other than water, the first organic solvent, the second organic solvent, and glycerin. The total percentage content of the water, the first organic solvent, the second organic solvent, and the glycerin in the aqueous medium is preferably at least 90% by mass, and further preferably 100% by mass.

### (First Organic Solvent)

The first organic solvent is at least one of 3-methyl-1,3-butanediol, ethylene glycol monomethyl ether, and dipropylene glycol. The percentage content of the first organic solvent in the ink of the present disclosure is preferably at least 5.0% by mass and no greater than 40.0% by mass, and more preferably at least 10.0% by mass and no greater than 30.0% by mass. As a result of the percentage content of the first organic solvent being set to at least 5.0% by mass, the ink of the present disclosure can further reliably form images with desired image density. As a result of the percentage content of the first organic solvent being set to no greater than 40.0% by mass, the ink of the present disclosure can have increased preservation stability.

### (Second Organic Solvent)

The second organic solvent has a surface tension of at least 25.0 mN/m and no greater than 35.0 mN/m. The surface tension of the second organic solvent is preferably at least 25.0 mN/m and no greater than 30.0 mN/m. As a result of the surface tension of the second organic solvent being set to at least 25.0 mN/m, the ink of the present disclosure can have increased ejection stability. As a result of the surface tension of the second organic solvent being set to no greater than 35.0 mN/m, the ink of the present disclosure can form images with excellent scratch resistance.

The second organic solvent may be any of the organic solvents listed below in Table 2, for example. The second organic solvent is preferably 1,2-pentanediol, 1,2-hexanediol, or 1,2-butanediol.

TABLE 2

| | Surface tension [mN/m] |
|---|---|
| 1,2-Pentanediol | 27.7 |
| 1,2-Hexanediol | 25.9 |
| 1,2-Butanediol | 31.6 |
| 3-Methoxy-1-butanol | 29.3 |
| Ethylene glycol monoethyl ether | 28.6 |
| Ethylene glycol monobutyl ether | 29.9 |
| Propylene glycol monomethyl ether | 26.9 |
| Propylene glycol monoethyl ether | 27.8 |
| Diethylene glycol monoethyl ether | 31.7 |
| Triethylene glycol monobutyl ether | 33.5 |

The percentage content of the second organic solvent in the ink of the present disclosure is preferably at least 3.0% by mass and no greater than 25.0% by mass, and more preferably at least 7.0% by mass and no greater than 15.0% by mass. As a result of the percentage content of the second organic solvent being set to at least 3.0% by mass, images formed with the ink of the present disclosure can have further increased scratch resistance. As a result of the percentage content of the second organic solvent being set to no greater than 25.0% by mass, the ink of the present disclosure can have increased ejection stability.

### (Glycerin)

The glycerin in the ink of the present disclosure functions as a moisturizing agent. As a result of the ink of the present disclosure containing glycerin, occurrence of nozzle clogging can be inhibited. The percentage content of the glycerin in the ink of the present disclosure is preferably at least 1.0% by mass and no greater than 10.0% by mass, and more preferably at least 3.0% by mass and no greater than 7.0% by mass.

### (Water)

The percentage content of the water in the ink of the present disclosure is preferably at least 30.0% by mass and no greater than 75.0% by mass, and more preferably at least 40.0% by mass and no greater than 60.0% by mass.

### [Additive]

The ink of the present disclosure may further contain a known additive (specific examples include a surfactant, a defoaming agent, a moisturizing agent, a solution stabilizer, an anti-drying agent, an antioxidant, a viscosity modifier, a pH adjuster, and an antifungal agent).

### (Surfactant)

The surfactant increases compatibility and dispersion stability of each component contained in the ink of the present disclosure. Examples of the surfactant include anionic surfactants, cationic surfactants, and nonionic surfactants. The surfactant is preferably a nonionic surfactant.

Examples of the nonionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and ethylene oxide adducts of acetylene glycol. The nonionic surfactant is preferably an ethylene oxide adduct of acetylene glycol.

In a case in which the ink of the present disclosure contains a surfactant, the percentage content of the surfactant in the ink is preferably at least 0.1% by mass and no greater than 3.0% by mass, and more preferably at least 0.2% by mass and no greater than 1.0% by mass.

### [Ink Preparation Method]

The ink of the present disclosure can be prepared for example by uniformly mixing a pigment dispersion containing the pigment, an emulsion containing the specific resin particles, water, the first organic solvent, the second organic solvent, and other components (e.g., glycerin and a surfactant) added as necessary using a stirrer. In preparation of the ink of the present disclosure, uniform mixing of the components may be followed by removal of foreign matter and coarse particles by filtering the resultant mixture using a filter (e.g., a filter with a pore size of 1 μm).

### Examples

The following describes Examples of the present disclosure. However, the present disclosure is not limited to Examples below.

### [Emulsion Preparation]

Emulsions (A) to (C) respectively containing specific resin particles (a) to (c) containing a fluorine-containing (meth)acrylic resin were prepared.

Emulsion (A): “SIFCLEAR (registered Japanese trademark) F104”, product of Emulsion Technology Co., Ltd., solid concentration: 47% by mass, D₅₀: 0.13 μm

Emulsion (B): “LUMIFLON (registered Japanese trademark) FD1000”, product of AGC Inc., solid concentration: 40% by mass, D₅₀: at least 0.05 μm and no greater than 0.1 μm

Emulsion (C): “ZEFFLE (registered Japanese trademark) SE-300A”, product of DAIKIN INDUSTRIES, LTD., solid concentration: 51% by mass, D₅₀: at least 0.15 μm and no greater than 0.18 μm

Note that the fluorine-containing (meth)acrylic resins contained in the respective specific resin particles (a) to (c) each were a block copolymer with a fluorine-containing block and a (meth)acrylic acid-based block.

### [Pigment Dispersion Preparation]

A pigment coating resin (R-1) including a repeating unit (MAA unit) derived from methacrylic acid, a repeating unit (MMA unit) derived from methyl methacrylate, a repeating unit (BA unit) derived from butyl acrylate, and a repeating unit (ST unit) derived from styrene was prepared. The pigment coating resin (R-1) had a mass average molecular weight (Mw) of 20,000 and an acid value of 100 mgKOH/g. The mass ratio of each repeating unit in the pigment coating resin (R-1) was “MAA unit: MMA unit: BA unit: ST unit=6.5:30.0:30.0:33.5. The pigment coating resin (R-1) was mixed with an aqueous solution of sodium hydroxide containing sodium hydroxide. The aqueous solution of sodium hydroxide contained sodium hydroxide in an amount 1.05 times the amount necessary for equivalent neutralization of the pigment coating resin (R-1). Through the above, the pigment coating resin (R-1) was neutralized with an equal amount (strictly, 105% amount) of KOH. As a result, a pigment coating resin solution containing the pigment coating resin (R-1) and water was obtained.

The aforementioned pigment coating resin solution, a black pigment (“MONARCH (registered Japanese trademark) 800”, product of Cabot Corporation), “OLFINE (registered Japanese trademark) E1010” (product of Nissin Chemical Industry Co., Ltd., ethylene oxide adduct of acetylenediol) as a nonionic surfactant, and ion exchange water were added into a vessel. The amount of each raw material added was such that the composition of the vessel contents was set to be 78.5% by mass of water, 6.0% by mass of the pigment coating resin (R-1), 15.0% by mass of the black pigment, and 0.5% by mass of the nonionic surfactant. The percentage content of the “water” is a total percentage content of the ion exchange water added into the vessel and water contained in the pigment coating resin solution (specifically, water contained in the aqueous solution of sodium hydroxide used for neutralizing the pigment coating resin and water produced through the neutralization reaction between the pigment coating resin and sodium hydroxide).

Subsequently, the vessel contents were dispersed using zirconia beads (particle diameter 0.5 mm) as a medium and a wet type disperser (“NANO GRAIN MILL”, product of Asada Iron Works Co., Ltd.). The conditions for the dispersion were as follows: temperature 10° C., peripheral speed 8 m/see, and discharge amount 300 g/min. Through the above, a pigment dispersion (CB) was obtained.

Pigment dispersions (Y), (M), and (C) were prepared according to the same method as that for preparing the pigment dispersion (CB) in all aspects other than that the type of the pigment used was changed as shown below.

Pigment dispersion (CB): black pigment (“MONARCH (registered Japanese trademark) 800, product of Cabot Corporation)

Pigment dispersion (Y): yellow pigment (“PALCOHOL YELLOW D1115J″, product of BASF Corporation)

Pigment dispersion (M): magenta pigment (“MAGENTA D4550”, product of BASF Corporation)

Pigment dispersion (C): cyan pigment (“HELIOGEN (registered Japanese trademark) BLUE D7088”, product of BASF Corporation)

### <Ink Preparation>

Any of the pigment dispersions (CB), (Y), (M), and (C), any of the emulsions (A) to (C), a surfactant (“POLYFLOR” (registered Japanese trademark) KL-850″, product of Kyoeisha Chemical Co., Ltd.), glycerin, a first organic solvent, a second organic solvent, a different organic solvent, and water were added into a beaker so as to achieve a corresponding composition shown below in Tables 3 to 5. Note that the amount of the pigment dispersion added was set such that the amount of the corresponding pigment (any of the black pigment, the yellow pigment, the magenta pigment, and the cyan pigment) in the beaker contents was as shown below in Tables 3 to 5. The amount of the emulsion added was set such that the amount of the corresponding one of the specific resin particles (a) to (c) in the beaker contents was as shown below in Tables 3 to 5.

The beaker contents were stirred at a rotational speed of 400 rpm using a stirrer (“THREE-ONE MOTOR (registered Japanese trademark) BL-600”, product of Shinto Scientific Co., Ltd.) for uniform mixing to obtain a mixed liquid. Next, the resultant mixed liquid was filtered using a filter (product of Membrane Solutions LLC, material: polytetrafluoroethylene (PTFE), pore size: 1 μm) to remove foreign matter and coarse particles contained in the mixed liquid. Through the above, inks of Examples 1 to 12 and Comparative Examples 1 to 5 were prepared.

TABLE 3

| Example | | 1 | 2 | 3 | 4 | 5 | 6 |
|---|---|---|---|---|---|---|---|
| Pigment | Type | Black | Black | Black | Black | Black | Black |
| | Part | 9.0 | 9.0 | 9.0 | 9.0 | 9.0 | 9.0 |
| Specific resin | Type | a | a | a | a | a | a |
| particles | Part | 5.0 | 5.0 | 5.0 | 5.0 | 5.0 | 3.0 |
| Surfactant [part] | | 0.5 | 0.5 | 0.5 | 0.5 | 0.5 | 0.5 |
| Glycerin [part] | | 5.0 | 5.0 | 5.0 | 5.0 | 5.0 | 5.0 |
| First organic | 3-Methyl-1,3-butanediol [part] | 20.0 | — | — | 20.0 | 20.0 | 20.0 |
| solvent | Dipropylene glycol [part] | — | 20.0 | — | — | — | — |
| | Ethylene glycol monomethyl ether [part] | — | — | 20.0 | — | — | — |
| Second | 1,2-Pentanediol [part] | 10.0 | 10.0 | 10.0 | — | — | 10.0 |
| organic | 1,2-hexanediol [part] | — | — | — | 10.0 | — | — |
| solvent | 1,2-butanediol [part] | — | — | — | — | 10.0 | — |

| | | | | | | |
|---|---|---|---|---|---|---|
| Ion exchange water [part] | Rest | Rest | Rest | Rest | Rest | Rest |
| Total [part] | 100.0 | 100.0 | 100.0 | 100.0 | 100.0 | 100.0 |

TABLE 4

| Examples | | 7 | 8 | 9 | 10 | 11 | 12 |
|---|---|---|---|---|---|---|---|
| Pigment | Type | Black | Black | Black | Yellow | Magenta | Cyan |
| | Part | 9.0 | 9.0 | 9.0 | 9.0 | 9.0 | 9.0 |
| Specific resin | Type | a | b | c | a | a | a |
| particles | Part | 7.0 | 5.0 | 5.0 | 5.0 | 5.0 | 5.0 |
| Surfactant [part] | | 0.5 | 0.5 | 0.5 | 0.5 | 0.5 | 0.5 |
| Glycerin [part] | | 5.0 | 5.0 | 5.0 | 5.0 | 5.0 | 5.0 |
| First organic | 3-Methyl-1,3-butanediol [part] | 20.0 | 20.0 | 20.0 | 20.0 | 20.0 | 20.0 |
| solvent | Dipropylene glycol [part] | — | — | — | — | — | — |
| | Ethylene glycol monomethyl ether [part] | — | — | — | — | — | — |
| Second | 1,2-Pentanediol [part] | 10.0 | 10.0 | 10.0 | 10.0 | 10.0 | 10.0 |
| organic | 1,2-hexanediol [part] | — | — | — | — | — | — |
| solvent | 1,2-butanediol [part] | — | — | — | — | — | — |

| | | | | | | |
|---|---|---|---|---|---|---|
| Ion exchange water [part] | Rest | Rest | Rest | Rest | Rest | Rest |
| Total [part] | 100.0 | 100.0 | 100.0 | 100.0 | 100.0 | 100.0 |

TABLE 5

| Comparative Example | | 1 | 2 | 3 | 4 | 5 |
|---|---|---|---|---|---|---|
| Pigment | Type | Black | Black | Black | Black | Black |
| | Part | 9.0 | 9.0 | 9.0 | 9.0 | 9.0 |
| Specific resin | Type | — | a | a | a | a |
| particles | Part | — | 5.0 | 5.0 | 5.0 | 5.0 |
| Surfactant [part] | | 0.5 | 0.5 | 0.5 | 0.5 | 0.5 |
| Glycerin [part] | | 5.0 | 5.0 | 5.0 | 5.0 | 5.0 |
| First organic | 3-Methyl-1,3-butanediol [part] | 20.0 | — | — | 20.0 | 20.0 |
| solvent | Dipropylene glycol [part] | — | — | — | — | — |
| | Ethylene glycol monomethyl ether [part] | — | — | — | — | — |
| Second | 1,2-Pentanediol [part] | 10.0 | 10.0 | 10.0 | — | — |
| organic | 1,2-hexanediol [part] | — | — | — | — | — |
| solvent | 1,2-butanediol [part] | — | — | — | — | — |
| Different | Diethylene glycol [part] | — | 20.0 | — | — | — |
| organic | 2,2-Dimethyl-1,4-butanediol [part] | — | — | 20.0 | — | — |
| solvent | Propylene glycol monomethyl ether [part] | — | — | — | 10.0 | — |
| | Propylene glycol [part] | — | — | — | — | 10.0 |

| | | | | | |
|---|---|---|---|---|---|
| Ion exchange water [part] | Rest | Rest | Rest | Rest | Rest |
| Total [part] | 100.0 | 100.0 | 100.0 | 100.0 | 100.0 |

Table 6 below shows the HSP and the R₀ of each pigment dispersions, the first organic solvent, and different organic solvents (diethylene glycol and 2.2-dimethyl-1.4-butanediol) used instead of the first organic solvent in Comparative Examples.

TABLE 6

| | dD | dP | dH | R₀ |
|---|---|---|---|---|
| Pigment dispersion (CB) | 16.7 | 14.1 | 17.2 | 5.5 |
| Pigment dispersion (Y) | 19.1 | 12.9 | 15.5 | 6.7 |
| Pigment dispersion (M) | 16.1 | 17.1 | 15.3 | 9.1 |
| Pigment dispersion (C) | 19.5 | 12.9 | 17.2 | 7.3 |
| 3-Methyl-1,3-butanediol | 16.8 | 16.8 | 16.8 | — |
| Dipropylene glycol | 16.5 | 10.6 | 17.7 | — |
| Ethylene glycol monomethyl ether | 16.0 | 8.2 | 15.0 | — |
| Diethylene glycol | 16.6 | 12.0 | 19.0 | — |
| 2,2-Dimethyl-1,4-butanediol | 16.4 | 7.5 | 16.5 | — |

Table 7 below shows each surface tension at 25° C. of the second organic solvents and different organic solvents (propylene glycol monomethyl ether and propylene glycol) used instead of the second organic solvent in Comparative Examples. 5

TABLE 7

| | Surface tension [mN/m] |
|---|---|
| 1,2-Pentanediol | 27.7 |
| 1,2-Hexanediol | 25.9 |
| 1,2-Butanediol | 31.6 |
| Propylene glycol monomethyl ether | 23.5 |
| Propylene glycol | 35.1 |

### <Evaluation>

With respect to each of the inks of Examples 1 to 12 and Comparative Examples 1 to 5, scratch resistance and image density of formed images were evaluated according to the following methods. Furthermore, REDs of the pigment and the first organic solvent (or a different organic solvent used instead of the first organic solvent) contained in each ink were calculated according to the method described in the embodiment. Results are shown below in Tables 8 and 9.

### [Evaluation Apparatus]

In the following evaluations, an inkjet ink recording apparatus (prototype of KYOCERA Document Solution Inc.) provided with a piezoelectric recording head (“KJ4B-QA”, product of KYOCERA Corporation) was used as an evaluation apparatus. An evaluation target (any of Examples 1 to 12 and Comparative Examples 1 to 5) was loaded in an ink tank of the evaluation apparatus. The evaluation apparatus was set so that the volume per one ejected drop of the ink was 11.5 pL.

### [Image Density]

Using the evaluation apparatus, a solid image (printing rate 100%) with a size of 2.3 cm×11.5 cm was formed on a sheet of copy paper (“COLOR COPY (registered Japanese trademark), product of Mondi plc, basis weight: 90 g/m², size: A4). Next, the sheet of the copy paper with the image formed thereon was left to stand for 24 hours in a normal-temperature and normal-humidity environment at a temperature of 25° C. and a relative humidity of 60%. Next, the image density of the solid image was measured using a reflectance densitometer (“FD-5”, product of KONICA MINOLTA JAPAN, INC.). In detail, the image densities of randomly selected 3 points on the solid image were measured and the average value thereof was taken to be an evaluation value. Measurement conditions included an observation light source of “D50”, an illumination condition of “M2”, a field of view of “2 degrees”, and a density status of “I”. Image density was evaluated according to the following criteria for each ink color.

### (Criteria for Image Density)

Cyan ink (Example 12): A (good) for image density of at least 0.93 and B (poor) for image density of less than 0.93

Magenta ink (Example 11): A (good) for image density of at least 0.87 and B (poor) for image density of less than 0.87

Yellow ink (Example 10): A (good) for image density of at least 1.08 and B (poor) for image density of less than 1.08

Black ink (Examples 1 to 9 and Comparative Examples 1 to 5): A (good) for image density of at least 1.10 and B (poor) for image density of less than 1.10

### [Scratch Resistance]

Using the evaluation apparatus, a solid image (printing rate 100%) with a size of 5 cm×4 cm was formed on a sheet of copy paper (“CC90”, product of Mondi plc, basis weight: 90 g/m², size: A4). A non-printed sheet (also referred to below as evaluation sheet) of the copy paper was placed on one side (side on which the solid image has been formed) of the sheet of the copy paper with the solid image thereon. Next, a rectangular parallelepiped weight (mass 1 kg) with a bottom having a dimension of 5 cm×4 cm was placed on the evaluation sheet. The position where the weight was placed was set so as to correspond to a location directly above the solid image. Next, the opposite ends of the evaluation sheet was held and the evaluation sheet was moved horizontally. In the horizontal movement, the evaluation sheet was moved so that the weight was moved back and forth over the solid image 5 times. The solid image was rubbed with a load of 1 kg against the evaluation sheet in the manner described above. Thereafter, the image density in an area of the evaluation sheet that had been in contact with the solid image was measured using a reflectance densitometer (“FD-9”, product of KONICA MINOLTA JAPAN, INC.). Measurement conditions included an observation light source of “D50”, an illumination condition of “M2”, a field of view of “2 degrees”, and a density status of “I”. In addition, in the measurement, the image density of an area of the evaluation sheet that had been out of contact with the solid image was taken to be a background value. A value (FD) obtained by subtracting the background value from the measured image density was taken to be an evaluation value of scratch resistance. Scratch resistance was evaluated according to the following criteria.

### (Criteria for Scratch Resistance)

A (good): FD of less than 0.02

B (poor): FD of at least 0.02

TABLE 8

| | | Example | | | | | | | |
|---|---|---|---|---|---|---|---|---|---|
| | | 1 | 2 | 3 | 4 | 5 | 6 | 7 | 8 |
| Image | Evaluation | 1.19 | 1.12 | 1.25 | 1.17 | 1.21 | 1.20 | 1.15 | 1.19 |
| density | value | | | | | | | | |
| | rating | A | A | A | A | A | A | A | A |
| Scratch | Evaluation | 0.006 | 0.004 | 0.018 | 0.005 | 0.012 | 0.018 | 0.005 | 0.011 |
| resistance | value | | | | | | | | |
| | rating | A | A | A | A | A | A | A | A |

| | | | | | | | | |
|---|---|---|---|---|---|---|---|---|
| RED | 1.096 | 0.649 | 1.174 | 1.096 | 1.096 | 1.096 | 1.096 | 1.096 |

TABLE 9

| | | Example | | | | Comparative Example | | | | |
|---|---|---|---|---|---|---|---|---|---|---|
| | | 9 | 10 | 11 | 12 | 1 | 2 | 3 | 4 | 5 |
| Image | Evaluation value | 1.18 | 1.15 | 0.94 | 1.02 | 1.17 | 1.08 | 1.25 | 1.08 | 1.13 |
| density | rating | A | A | A | A | A | B | A | B | A |
| Scratch | Evaluation value | 0.012 | 0.006 | 0.008 | 0.005 | 0.022 | 0.002 | 0.340 | 0.004 | 0.023 |
| resistance | rating | A | A | A | A | B | A | B | A | B |

| | | | | | | | | | |
|---|---|---|---|---|---|---|---|---|---|
| RED | 1.096 | 1.014 | 1.017 | 0.988 | 1.096 | 0.507 | 1.213 | 1.096 | 1.096 |

As shown in Tables 1 to 9, each of the inks of Examples 1 to 12 contained a pigment, specific resin particles, and an aqueous medium. The aqueous medium contained water, a first organic solvent, and a second organic solvent. The first organic solvent was at least one of 3-methyl-1,3-butanediol, ethylene glycol monomethyl ether, and dipropylene glycol. The second organic solvent had a surface tension of at least 25.0 mN/m and no greater than 35.0 mN/m. The specific resin particles contained a fluorine-containing (meth)acrylic resin. As a result of having the above features, the inks of Examples 1 to 12 formed images with desired image density and excellent scratch resistance.

By contrast, due to the ink of Comparative Example 1 not containing the specific resin particles, the image formed with the ink had poor scratch resistance.

The ink of Comparative Example 2 contained diethylene glycol, which is an organic solvent with an excessively low RED to the pigment, instead of the first organic solvent. The pigment of the ink of Comparative Example 2 is thought to have extremely high preservation stability. As a result, the pigment of the ink of Comparative Example 2 having landed on the sheet of the recording medium did not agglomerate on the surface of the recording medium, leading to poor image density.

The ink of Comparative Example 3 contained 2,2-dimethyl-1,4-butanediol, which is an organic solvent with an excessively high RED to the pigment, instead of the first organic solvent. The pigment in the ink of Comparative Example 3 is thought to have extremely low preservation stability. As a result, the pigment of the ink of Comparative Example 3 having landed on the recording medium excessively agglomerate on the surface of the recording medium, leading to poor scratch resistance of the formed image.

The ink of Comparative Example 4 contained propylene glycol monomethyl ether, which is an organic solvent with a surface tension of less than 25.0 mN/m, instead of the second organic solvent. It is thought that the solvent of the ink of Comparative Example 4 having landed on the recording medium rapidly penetrated into the recording medium, and along with this, the pigment also penetrated into the recording medium. As a result, the image formed with the ink of Comparative Example 4 was poor in image density.

The ink of Comparative Example 5 contained propylene glycol, which is an organic solvent with a surface tension of greater than 35.0 mN/m, instead of the second organic solvent. Due to the solvent insufficiently penetrating into the recording medium after the ink of Comparative Example 5 landed on the recording medium, the formed image was poor in scratch resistance.

What is claimed is:

1. An inkjet ink comprising:
a pigment;
specific resin particles; and
an aqueous medium, wherein
the aqueous medium contains water, a first organic solvent, and a second organic solvent,
the first organic solvent is at least one of 3-methyl-1,3-butanediol, ethylene glycol monomethyl ether, and dipropylene glycol,
the second organic solvent has a surface tension of at least 25.0 mN/m and no greater than 35.0 mN/m, and
the specific resin particles contain a fluorine-containing (meth)acrylic resin.

2. The inkjet ink according to claim 1, wherein
the second organic solvent contains 1,2-pentanediol, 1,2-exhanediol, or 1,2-butanediol.

3. The inkjet ink according to claim 1, wherein
the specific resin particles have a percentage content of at least 2.0% by mass and no greater than 8.0% by mass.

4. The inkjet ink according to claim 1, wherein
the first organic solvent has a percentage content of at least 5.0% by mass and no greater than 40.0% by mass.

5. The inkjet ink according to claim 1, wherein
the second organic solvent has a percentage content of at least 3.0% by mass and no greater than 20.% by mass.
